(19) United States
(12) Patent Application Publication
(10) Pub. No.: US 2010/0165116 A1
(43) Pub. Date: Jul. 1, 2010

(54) CAMERA WITH DYNAMIC CALIBRATION AND METHOD THEREOF

(75) Inventors: Hsiang-Wen Hsieh, Miaoli County (TW); Hung-Hsiu Yu, Changhua County (TW); Wei-Han Wang, Taipei County (TW); Chin-Chia Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/391,264

(22) Filed: Feb. 24, 2009

(30) Foreign Application Priority Data
Dec. 30, 2008 (TW) 97151445

(51) Int. Cl. H04N 17/02

(52) U.S. Cl. 348/187; 348/E17.004

(57) ABSTRACT

A camera with dynamic calibration and a method thereof is provided. The camera is first subject to an initial calibration. Then, a motion amount of the camera is calculated, and a plurality of motion amount estimation samples of the camera is generated according to the motion amount. Then, a weight of each of the motion amount estimation samples is calculated. Thereafter, the plurality of motion amount estimation samples is re-sampled based on the weights, and the camera is calibrated by the re-sampled estimated motion samples.

### CROSS-REFERENCE TO RELATED APPLICATION

This application claims the priority benefit of Taiwan application serial no. 97151445, filed on Dec. 30, 2008. The entirety of the above-mentioned patent application is hereby incorporated by reference herein and made a part of specification.

### BACKGROUND OF THE INVENTION

1. Field of the Invention

The present invention relates to a calibration method of a camera.

2. Description of Related Art

For utilization of environmental security, a camera is generally used to monitor environmental status. Application of performing an accurate abnormity monitoring through an environmental image sensor has become a main development trend of such kind of product. Recently, with development of localization and navigation technology of service robots, integration of such kind of sensor is regarded as one of key techniques that influence an actual performance of the service robot.

For a conventional camera, the calibration operation must be performed through a standard calibration board or predetermined environmental landmarks to complete calibrations of intrinsic and extrinsic parameters of the camera.

FIG. 1 schematically illustrates a conceptual diagram showing image coordinates and environmental coordinates of a general camera. As shown in FIG. 1, [u, v] represents a position on an image plane, [Xc, Yc, Zc] represents camera spatial coordinates, and [Xw, Yw, Zw] represents world spatial coordinates. Calibration of the intrinsic parameters determines a focus position of the camera, an image distortion, a position of an image center, etc., which is used for determining a relation of [u, v] and [Xc, Yc, Zc]. The extrinsic parameter represents a position of the camera relative to the world coordinates, i.e., a conversion between [Xc, Yc, Zc] and [Xw, Yw, Zw].

Such calibration method is a one-step calibration procedure, i.e., an off-line calibration method, which generally takes a relatively long time to complete the calibration of a single camera. Meanwhile, settings for completing the calibration of the camera have to be fixed; namely, the focus or position of the camera has to be fixed. When adjusting the focus of the camera, for example, zoom in or zoom out, or when changing the position of the camera to alter a monitoring environment of the camera (for example, a pan or a tilt motion usually performed by a general pan-tilt-zoom (PTZ) camera), the camera has to be re-calibrated. Therefore, application flexibility of such technique is limited, and more cameras has to be set for monitoring a relatively large range, so that costs for environmental monitoring, abnormity tracing and robot positioning are increased.

Presently, the related patents or techniques of camera positioning mainly apply a standard calibration board (U.S. Pat. No. 6,985,175B2 and U.S. Pat. No. 6,437,823B1) or designing a special landmark in the environment to extract related information from the calibration board or the landmark in the environment for corresponding to the world coordinates thereof, so as to achieve calibration of the camera parameters. In case of applying the calibration board, size of a standard pattern (corresponding to size of the world coordinates) within the calibration board has to be measured in advance, and the calibration board is disposed at any height, angle or position within a viewing coverage of the camera, so as to capture images used for calibration. Then, a pixel position corresponding to each grid of the image is obtained based on image processing, and the intrinsic and extrinsic parameters of the camera are calculated, so as to complete the camera calibration procedure. In case of designing the environmental landmarks, capturing of different calibration images is unnecessary. In such method, positions of different world coordinates on the ground are measured and marked in advance, and then pixel positions of the landmarks on the image are obtained via the image processing, so as to complete the camera calibration corresponding to the world coordinates.

Moreover, U.S. Pat. No. 6,101,455 discloses a camera calibration performed through a robot arm and a point-structured light. The concept of such patent is to calibrate the camera of different positions according to position information of the robot arm moved in the space, a shape of the point-structured light projected to a front-end of the robot arm and a pattern on the calibration board that is captured by the camera.

Therefore, for a current dynamic calibration of the camera, the calibration has to be performed according to an external environmental setting, and if the position of the camera is varied, the environmental setting has to be reset, so as to implement a next calibration. Therefore, a real-time calibration method without limitations of variation of the camera position and variation of the environmental setting is required.

### SUMMARY OF THE INVENTION

Accordingly, the present invention is directed to a dynamic calibration method of a camera and a camera with such dynamic calibration. During an operation process of the camera, when the camera performs a pan/tilt motion, calibration parameters of the camera are dynamically estimated, so as to provide a more effective system matching requirements of large-range accurate monitoring and mobile carrier positioning, etc.

The present invention provides a dynamic calibration method of a camera, wherein the camera applies a point light source. First, the camera is subject to an initial calibration. Next, the point light source projects light to an external environment to generate a light spot, and a position of the light spot is recorded as a world coordinate. Next, the camera obtains a first light spot image of the light spot, and records a position of the first light spot image as a first image coordinate. When the camera is moved, a motion amount of the camera is calculated to generate a plurality of motion amount estimation samples, wherein the plurality of motion amount estimation samples represents estimation samples of camera parameters. In cast that the point light source is not moved, the moved camera images the light spot and obtain a second image coordinate of a second light spot image. Next, a dynamic calibration is procedure is performed according to the motion amount estimation samples and the second image coordinate, so as to generate an optimal calibration parameter estimation result.

The aforementioned dynamic calibration procedure further comprises a predicting procedure, an update procedure and a re-sampling procedure. In the predicting procedure, the motion amount estimation samples are generated according to the first light spot image and the motion amount of the camera. In the update procedure, a weight is assigned to each of the motion amount estimation samples, so as to update the motion amount estimation samples. In the re-sampling procedure, the plurality of motion amount estimation samples is re-sampled according to the weights assigned to motion amount estimation samples, so as to guarantee a convergence of the estimation samples.

The present invention further provides a dynamic calibration method of a camera. First, the camera is subject to an initial calibration. Next, a motion amount of the camera is calculated. Next, a plurality of motion amount estimation samples of the camera is generated according to the motion amount. Next, a weight of each of the motion amount estimation samples is calculated. Next, the plurality of motion amount estimation samples is re-sampled based on the weights. Finally, an optimal estimation sample is obtained according to the re-sampled motion amount estimation samples, so as to calibrate the camera.

The present invention further provides a camera with dynamic calibration, which comprises a visual sensing unit, a camera calibration parameter estimation unit, and a spatial coordinate conversion unit. The visual sensing unit senses a light spot formed by a point light source to form an image light spot, and controls a motion of the camera. The camera calibration parameter estimation unit generates a plurality of motion amount estimation samples according to the point light source, the image light spot and a motion amount of the camera, so as to perform a dynamic calibration procedure. The spatial coordinate conversion unit converts a world coordinate of the light spot and an image coordinate of the image light spot. Wherein, a position of the light spot is recorded, and the camera obtains a first light spot image of the light spot, and records a position of the first light spot image as a first image coordinate. When the camera is moved, the motion amount of the camera is calculated to generate the motion amount estimation samples. In case that the point light source is not moved, the moved camera images the light spot to obtain a second image coordinate of a second light spot image. Then, the dynamic calibration procedure is performed according to the motion amount estimation samples and the second image coordinate, so as to generate an optimal calibration parameter estimation result.

In the present invention, a PTZ camera and a point light source projection apparatus are integrated, and the estimation of the dynamic camera calibration parameters is achieved through a motor signal within the PTZ camera and a projection position on the ground projected by the point light source. For the calibrated camera, the time spent for preparing the related calibration images for recalibration due to the motion of the camera can be avoided, so that a monitoring angle of the camera can be adjusted at any moment, and a detecting range and a tracing range of a moving object can be enlarged. Meanwhile, device hardware can be integrated into an embedded smart camera (a camera having an embedded system), so as to increase an application portability and reduce the cost.

In order to make the aforementioned and other objects, features and advantages of the present invention comprehensible, several embodiment accompanied with figures is described in detail below.

### BRIEF DESCRIPTION OF THE DRAWINGS

The accompanying drawings are comprised to provide a further understanding of the invention, and are incorporated in and constitute a part of this specification. The drawings illustrate embodiments of the invention and, together with the description, serve to explain the principles of the invention.

FIG. 1 is a schematic diagram illustrating a concept of image coordinates and environmental coordinates of a general camera.

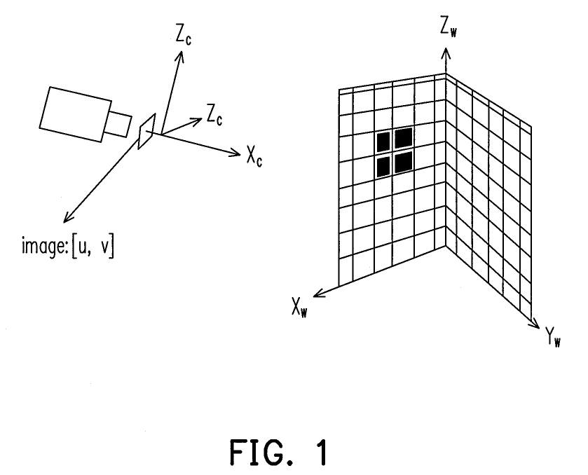

FIG. 2 is a schematic diagram illustrating an operation concept of a system 100 according to an embodiment of the present invention.

FIG. 3 is a schematic diagram illustrating a system structure according to an embodiment of the present invention.

FIG. 4 is a schematic diagram illustrating an operation sequence of the present embodiment.

FIG. 5 is an operation flowchart of the present embodiment.

FIG. 6 is a schematic diagram illustrating a concept of back-projection errors occurred during dynamic calibration.

### DESCRIPTION OF EMBODIMENTS

A sensor integration and a pose estimation techniques used for achieving the present invention can perform an on-line camera calibration by integrating a motor rotation signal of the camera and a light spot projected on the ground by a point light source projection module of the camera. Several embodiments are provided for description as follows.

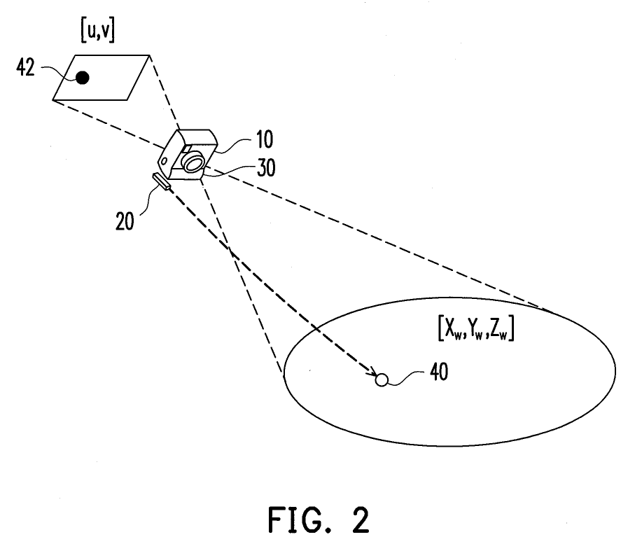

FIG. 2 is a schematic diagram illustrating an operation concept of a system according to an embodiment of the present invention. As shown in FIG. 2, a camera 10 is equipped with a point light source 20, and the point light source 20 is used for providing a light spot for the camera calibration. When a light beam emitted from the point light source 20 forms a light spot 40 in the environment, an image light spot 42 of the light spot 40 is then formed on an image plane of camera 10. The light spot 40 formed in the environment is defined by world coordinates [Xw, Yw, Zw], and the image light spot 42 is defined by image coordinates [u, v]. the camera 10 can be further controlled by a motor 30 to carry out a motion such as a pan or a tilt motion of the camera 10 in the space.

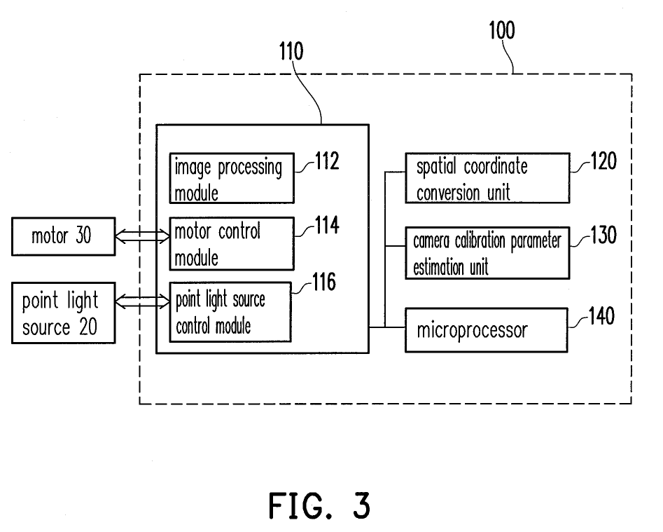

FIG. 3 is a schematic diagram illustrating a system structure according to an embodiment of the present invention. As shown in FIG. 3, the system 100 comprises a visual sensing unit 110, a spatial coordinate conversion unit 120 and a camera calibration parameter estimation unit 130, etc. The above units 110, 120 and 130 can be controlled by a microprocessor 140 of the system 100, and a coupling relation thereof is determined according to an actual implementation, and FIG. 3 is only used for an example.

As shown in FIG. 3, the visual sensing unit 110 further comprises an image processing module 112, a motor control module 114 and a point light source control module 116. The visual sensing unit 110 is a hardware control layer, and is used for image processing, motor signal processing and point light source controlling. The image processing module 112 is used for pre-processing the image captured by the camera. The motor control module 114 is used for controlling motions of the camera, and the point light source control module 116 is used for controlling projections of the light spot.

The camera calibration parameter estimation unit 130 is mainly used for on-line dynamic calibration parameter estimation, by which a fixed-position calibration parameter estimation or a dynamic-position calibration parameter estimation can be performed according to an actual requirement. The camera calibration parameter estimation unit 130 is basically used for setting an initial calibration procedure, predicting the calibration parameter estimation samples and updating calibration parameter estimation samples, etc. In other words, the camera calibration parameter estimation unit 130 is used to predict and then update the calibration parameter estimation samples.

The spatial coordinate conversion unit 120 performs conversions between the image coordinates [u, v] and the world coordinates [Xw, Yw, Zw]. The spatial coordinate conversion unit 120 comprises functions or modules for converting the image coordinates into the world coordinates, or converting the world coordinates into the image coordinates, which can be implemented by system software. The spatial coordinate conversion unit 120 is used for assisting the camera calibration parameter estimation unit 130 to update the calibration parameter estimation samples. The spatial coordinate conversion unit 120 can convert data on the image plane [u, v] into the world coordinates [Xw, Yw, Zw], and compares it to the light spot projected on the ground, so as to update the estimation samples.

The above units 110, 120 and 130 are, for example, implemented by embedded systems of the camera, such as an advanced RISC machine (ARM) or field programmable gate arrays (FPGA), etc.

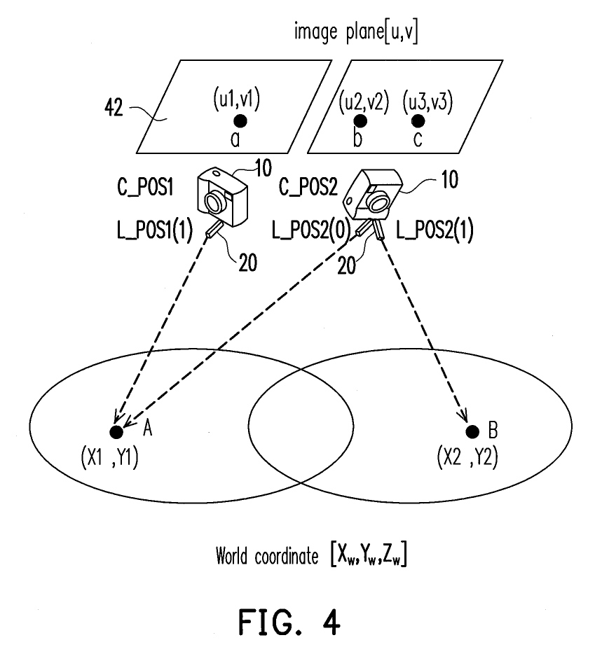

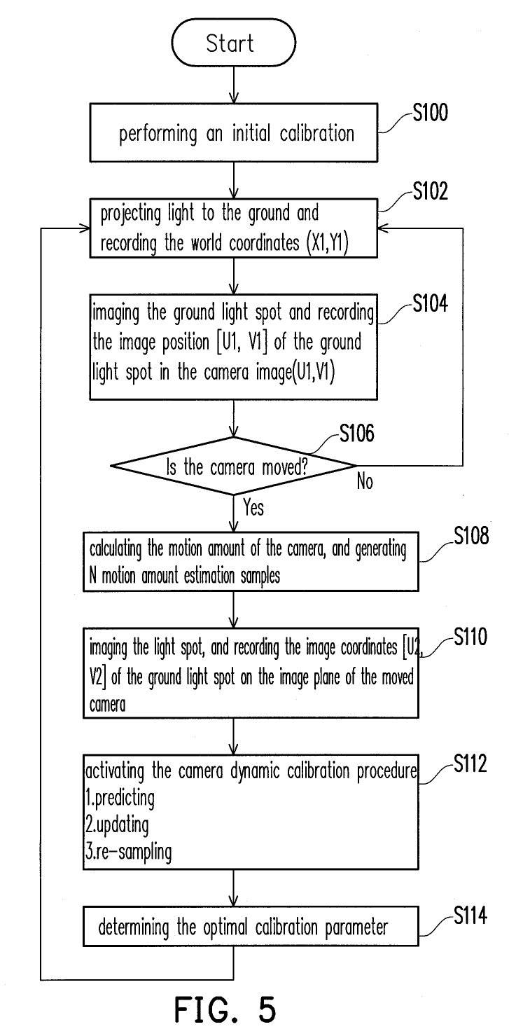

Operations of the present embodiment are described below. FIG. 4 is a schematic diagram illustrating an operation sequence of the present embodiment, and FIG. 5 is an operation flowchart of the present embodiment.

As shown in FIG. 4, an initial position of the camera 10 is C_POS1, and now an initial position of the point light source 20 is L_POS1(1). In this stage, the light emitted from the point light source 20 forms a light spot A in the environment, and the corresponding world coordinates of the light spot A is [X1, Y1]. Moreover, when the camera 10 is moved, a position thereof is changed to C_POS2. During such process, the dynamic calibration procedure of the camera 10 is activated. First, the point light source 20 still projects light to the light spot A [X1, Y1], i.e. the position of the point light source 20 is L_POS2(0). Then, the position of the point light source 20 is moved to L_POS2(1). In the following content, the dynamic calibration of the camera 10 using the point light source 20 is described in detail.

As shown in FIG. 4, first, the camera 10 is located at the initial position C_POS1, and the initial position of the point light source 20 is L_POS1(1). Now, the calibration of the camera 10 is completed. As defined above, the world coordinates of the light spot projected by the point light source 20 is [X1, Y1], and the image coordinates of the light spot formed by the camera 10 on the image plane of the sensor thereof is [U1, V1].

Next, when the camera 10 is moved from the position C_POS1 to the position C_POS2, the dynamic calibration procedure of the camera 10 is activated. When the dynamic calibration procedure is activated, the point light source 20 is not moved, i.e., the position L_POS2(0) and the position L_POS(1) are the same, and a projection position of the point light source 20 is still the position [X1, Y1] in the environment. However, since the camera 10 is moved, the image coordinates on the image plane is moved from [U1, V1] to [U2, V2]. Namely, though the imaging position is changed from [U1, V1] to [U2, V2], the position of the light spot in the environment is not changed, and is maintained to the position [X1, Y1].

According to the aforementioned camera dynamic calibration procedure, N camera motion amount estimation samples, i.e., N camera calibration parameter solutions are generated according to an actual rotation amount of the motor 30 controlled by the camera 10, and a random variance probably generated during an actual rotation.

According to the aforementioned dynamic calibration procedure, the image coordinate [U2, V2] of the light spot formed by the light source 20 at the position L_POS2 is projected back to world coordinate positions (xi, yi) through the N camera calibration parameter solutions, wherein i=1−N. Next, the N possible positions (xi, yi) are compared with the actual light spot position [X1, Y1]. Then, weights of the N possible positions (xi, yi) are calculated according to different distances between the actual light spot position [X1, Y1] and the N possible positions (xi, yi). After the weights are obtained, the closest distance represents that the utilized calibration parameter solution has the highest weight, and the one having the highest weight is regarded as a result of the calibration parameter.

Thereafter, new N camera motion amount estimation samples are generated according to the weights of the N calibration parameter solutions, so as to substitute the previous N calibration parameter solutions to guarantee a convergence of the system. In other words, after several rounds of operations of the N calibration parameter solutions and the weights thereof, a set of the N calibration parameter solutions can be more and more convergent, and accuracy of the camera is increasingly improved, so as to achieve the dynamic calibration of the camera.

After the calibration is completed, the point light source 20 is moved to the position L_POS2(1). Now, if the camera 10 receives a rotation command, the aforementioned dynamic calibration procedure is then repeated to perform the same calibration procedure. Conversely, the camera 10 maintains a latest result of the calibration parameter.

FIG. 5 is an operation flowchart of the present embodiment. Referring to FIG. 4 and FIG. 5, in step S100, the camera is subject to an initial calibration, namely, the parameters of the camera 10 are calibrated when the camera 10 is in a static state. Such step is the same to the calibration procedure performed when the camera 10 of FIG. 4 is located at the position C_POS1 and the point light source 20 is located at the position L_POS1(1).

Next, in step S102, the point light source 20 projects a light beam in the environment to form a light spot A on the ground, and the world coordinates [X1, Y1] of the light spot is recorded.

Next, in step S104, the camera 10 images the light spot, and records the imaging position [U1, V1] (i.e., the image coordinates on the image plane) of the ground light spot A that is formed on the image plane.

Next, in step S106, it is determined whether the camera is moved, and if the camera is not moved, the step S102 is repeated, and the dynamic calibration procedure is not performed. Conversely, if the camera is moved, a step S108 is executed, in which a motion amount of the camera is calculated, so as to generate N motion amount estimation samples.

Next, in step S110, the light spot B is imaged, and the image coordinates [U2, V2] of the ground light spot B formed on the image plane after the camera is moved is recorded.

Thereafter, in step S112, the camera dynamic calibration procedure is activated, and such dynamic calibration procedure comprises three main procedures of predicting, updating and re-sampling.

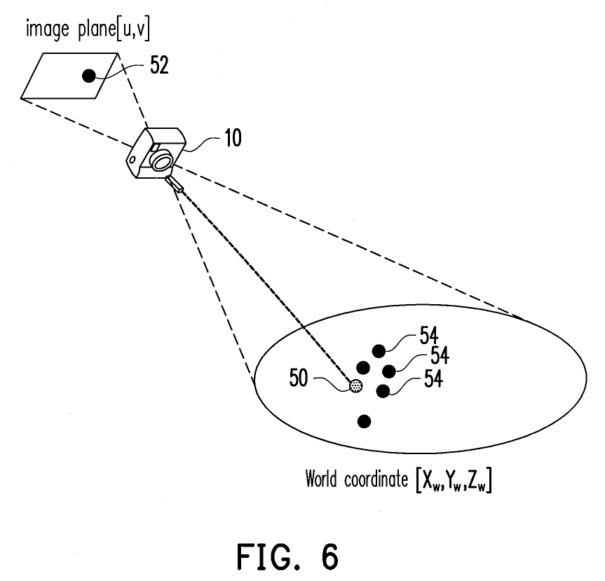

Referring to FIG. 4, according to the predicting procedure, the image coordinates [U2, V2] of the light spot formed by the light source 20 at the position L_POS2 is projected back to the world coordinate positions (xi, yi) (i.e., the N motion amount estimation samples) through the N camera calibration parameter solutions. In other words, possible positions of the image coordinates [U2, V2] corresponding to the world coordinates are estimated, so as to generate N possible solutions (xi, yi), wherein i=1−N, namely, N possible solutions on the world coordinates are estimated. FIG. 6 is a schematic diagram of the above concept. According to FIG. 6, the projected world coordinate positions 54 are estimated according to the light spot 52 on the image plane, and the projection position of the point light source is 50.

According to the updating procedure, distance differences between the N possible solutions and the actual world coordinates are respectively calculated, and weights are assigned to the N possible solutions according to the distance differences, so as to distinguish correlativity between the N possible solutions and the actual world coordinates. The closest distance represents that the utilized calibration parameter solution has the highest weight, and the one having the highest weight is regarded as a result of the calibration parameter. Referring to FIG. 6, the system calculates distance errors reproj_errᵢ between the projection position 50 of the point light source and the estimation positions 54, wherein i=1−N.

The re-sampling procedure is to regenerate new N camera motion amount estimation samples according to the aforementioned weights, so as to substitute the previous N calibration parameter solutions. In other words, the re-sampling is performed according to the weights, so as to guarantee the convergence of the system can be increasingly improved, and the camera motion amount estimation samples can be closer to the actual world coordinates.

Finally, in step S114, the optimal result of the calibration parameter estimation is determined, and the point light source 20 is returned back to the initial position. In FIG. 4, the position C_POS1 of the camera 10 and the position L_POS1(1) of the point light source 20 are defined as initial positions. When the camera 10 is moved to the position C_POS2, the position of the light spot projected by the point light source 20 is not changed, namely, the positions L_POS2(0) and L_POS1(1) are the same. Now, the dynamic calibration is performed, and after the calibration is completed, the point light source 20 is returned back to the initial position, i.e., the position L_POS2(1).

In the present embodiment, at each time point for the camera capturing an image of the environment, the dynamic camera calibration parameter estimation is performed according to the motor signal of the camera and a relative position of the light spot on the ground that is projected by the point light source. The flowchart of FIG. 5 comprises three main parts. The first part is to establish the initial calibration parameters of the camera. According to such part, intrinsic parameters and extrinsic parameters of the camera located at a fixed position can be obtained, wherein the intrinsic parameters comprise a focus of the camera, an imaging center, a distortion correction coefficient, etc., and the extrinsic parameters represent a position of the camera relative to the world coordinates, which is also an estimation part of the dynamic calibration parameters, which can be represented by a following equation (1):

X_{I}=KX_{C}, X_{C}=RX_{W}+T (1)

wherein, X_{I}=KX_{C} represents a relation between the image plane X_{I} and the camera spatial coordinate X_{C}, wherein K represents an intrinsic parameter matrix. X_{C}=RX_{W}+T represents a relation between the camera spatial coordinate and the world coordinate. R and T respectively represent a rotational and a translational matrix of initial extrinsic parameters.

When the camera performs a pan/tilt motion from the initial position thereof, states of the camera can be represented by following equations (2)-(4):

X_{C}=Rpan(RX_{w}+T)+Tpan (2)

X_{C}=Rₜᵢₗₜ [Rpan(RX_{w}+T)+Tₚₐₙ]+Tₜᵢₗₜ (3)

X_{C}=RₜᵢₗₜRₚₐₙRX_{w}+RₜᵢₗₜRₚₐₙT+RₜᵢₗₜTₚₐₙ+Tₜᵢₗₜ (4)

wherein Rₚₐₙ is a rotational matrix corresponding to the pan motion of the camera, Rₜᵢₗₜ is a rotational matrix corresponding to the tilt motion, and Tₚₐₙ and Tₜᵢₗₜ are respectively a translational matrix corresponding to the pan/tilt motion.

The second part is to establish camera calibration parameter models including a motion model and a measurement model. The motion model is used to calculate a relative rotation and translation amount according to a motion difference of the camera motor, and predict the calibration parameters according to a concept of the estimation samples, which is the same to the step S108 of FIG. 5, in which the motion amount of the camera is calculated and the estimation samples are generated. Such step is represented by following equations (5)-(9), and in the equation (9), S^{t}_{C} represents a state at a time point t, i.e. the prediction of the camera calibration parameter at the time point t.

R^{t}ₚₐₙ=R^{t-1}ₚₐₙ+(δ_{R}_{_{—}}ₚₐₙ−N(0, σᵣₚₐₙ)) (5)

R^{t}ₜᵢₗₜ=R^{t-1}ₜᵢₗₜₙ+(δ_{R}_{_{—}}ₚₐₙ−N(0, σᵣₜᵢₗₜ)) (6)

T^{t}ₚₐₙ=T^{t-1}ₚₐₙ+(δ_{T}_{_{—}}ₚₐₙ−N(0, σₜₚₐₙ)) (7)

T^{t}ₜᵢₗₜ=T^{t-1}ₜᵢₗₜₙ+(δ_{T}_{_{—}}ₚₐₙ−N(0, σₜₜᵢₗₜ)) (8)

S^{t}_{C}=[R^{t}ₜᵢₗₜ, R^{t}ₚₐₙ, T^{t}ₜᵢₗₜ, T^{t}ₚₐₙ] (9)

In the present embodiment, the rotation or translation amount generated at the time point t is predicted according to a result generated at the t−1 time point and a variable δ and a random noise N(0, σ). The measurement model is used to update a motion position calculated based on the motion model through an imaging position on the image plane that is formed by the light spot projected on the ground, so as to calculate the weight of each of the estimation samples, which is shown as following equations (10) and (11):

reproj_errᵢ=Dis(LaserBeamPos, Fᵢ(beam_pix_pos)) (10)

e^{(-λ·reproj}^{_{—}}^{eri)} (11)

wherein, reproj_err represents an error amount generated when the image coordinates imaged on the image plane by the light spot is projected to the world coordinates through each of the estimation sample predictions with the calculated calibration parameter, which is shown as FIG. 6, and the weight of each sample is calculated according to the equation (11).

The third part is to re-sample the estimation samples according to the weight calculation result of the second part, wherein the sample with a higher weight is more liable to be selected, so that the convergent effect of the estimation results of the calibration parameters can be achieved, and accordingly the estimation result of the calibration parameter is obtained.

In summary, according to the above embodiments, the PTZ camera and the point light source projection apparatus are integrated, and the estimation of the dynamic camera calibration parameters is achieved through a motor signal within the PTZ camera and the projection position of the point light source on the ground.

Moreover, for the calibrated camera, the time spent for preparing the related calibration images for recalibration due to the motion of the camera can be avoided, so that a monitoring angle of the camera can be adjusted at any moment, and a detecting range and a tracing range of a moving object can be enlarged. Meanwhile, device hardware can be integrated into an embedded smart camera, so as to increase application portability and reduce the cost.

In addition, in the present invention, the motor information generated when the general PTZ camera is operated, and a system state estimation technique of a point light source emitter are combined to establish a camera auto-calibration system for a dynamic environment. After an off-line calibration is performed to the camera in advance for the first time, the related devices and the method provided by the present invention can dynamically estimate the calibration parameters of the camera during the operation process of the camera or when the camera performs the pan/tilt motion, so as to resolve a problem of the related art that the conventional camera has to additionally capture images of a calibration board or environmental landmarks for recalibration. Therefore, a more effective system that matches requirements of large-range accurate monitoring and mobile carrier positioning, etc., is provided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dynamic calibration method of a camera, wherein the camera applies a point light source, the calibration method of the camera comprising:
performing an initial calibration to the camera;
projecting light to an external environment by the point light source to generate a light spot and recording a position of the light spot as a world coordinate, and obtaining a first light spot image of the light spot by the camera and recording a position of the first light spot image as a first image coordinate;
calculating a motion amount of the camera to generate a plurality of motion amount estimation samples when the camera is moved;
imaging the light spot by the moved camera and obtaining a second image coordinate of a second light spot image of the light spot in cast that the point light source is not moved;
performing a dynamic calibration procedure according to the motion amount estimation samples and the second image coordinate; and
generating an optimal calibration parameter estimation result according to the dynamic calibration procedure,
wherein the dynamic calibration procedure further comprises:
a predicting procedure, generating the motion amount estimation samples according to the first light spot image and the motion amount of the camera;
an updating procedure, respectively assigning a weight to each of the motion amount estimation samples, so as to update the motion amount estimation samples; and
a re-sampling procedure, re-sampling the plurality of motion amount estimation samples according to the updated motion amount estimation samples.

2. The dynamic calibration method of a camera as claimed in claim 1, wherein the weight is determined according to a distance difference between each of the motion amount estimation samples and an actual position of the light spot projected by the point light source.

3. The dynamic calibration method of a camera as claimed in claim 2, wherein the weight increases as the distance difference decreases.

4. The dynamic calibration method of a camera as claimed in claim 1, wherein the initial calibration comprises calibrations of intrinsic parameters and extrinsic parameters of the camera.

5. The dynamic calibration method of a camera as claimed in claim 1, wherein the motion amount of the camera comprises a pan motion and a tilt motion.

6. The dynamic calibration method of a camera as claimed in claim 5, wherein the motion amount further comprises a random noise.

7. A dynamic calibration method of a camera, comprising:
performing an initial calibration to the camera;
calculating a motion amount of the camera;
generating a plurality of motion amount estimation samples of the camera according to the motion amount;
calculating a weight of each of the motion amount estimation samples;
updating the motion amount estimation samples according to the weights, and re-sampling a plurality of motion amount estimation samples; and
calibrating the camera according to the re-sampled motion amount estimation samples.

8. The dynamic calibration method of a camera as claimed in claim 7, wherein the motion amount of the camera comprises a pan motion and a tilt motion.

9. The dynamic calibration method of a camera as claimed in claim 7, wherein the motion amount further comprises a random noise.

10. The dynamic calibration method of a camera as claimed in claim 7, wherein the initial calibration comprises calibrations of intrinsic parameters and extrinsic parameters of the camera.

11. A camera with dynamic calibration, comprising:
a visual sensing unit, sensing a light spot formed by a point light source to form an image light spot, and controlling a motion of the camera;
a camera calibration parameter estimation unit, generating a plurality of motion amount estimation samples according to the point light source, the image light spot and a motion amount of the camera, so as to perform a dynamic calibration procedure; and
a spatial coordinate conversion unit, converting a world coordinate of the light spot and an image coordinate of the image light spot, wherein a position of the light spot is recorded, and the camera obtains a first light spot image of the light spot, and records a position of the first light spot image as a first image coordinate;
when the camera is moved, the motion amount of the camera is calculated to generate the motion amount estimation samples;
in case that the point light source is not moved, the moved camera images the light spot and obtains a second image coordinate of a second light spot image of the light spot;
the dynamic calibration procedure is performed according to the motion amount estimation samples and the second image coordinate; and
an optimal calibration parameter estimation result is generated according to the dynamic calibration procedure.
